(19) United States
(12) Patent Application Publication
(10) Pub. No.: US 2024/0279818 A1
(43) Pub. Date: Aug. 22, 2024

(54) METHOD FOR SELECTING CHEMICAL AGENTS FOR REMOVING SCALE

(71) Applicant: FUJI ELECTRIC CO., LTD., Kawasaki-shi (JP)

(72) Inventors: Shinya UI, Tokyo (JP); Taichiro KATO, Tokyo (JP); Azusa WADA, Tokyo (JP); Hideki YAMAMOTO, Osaka (JP)

(73) Assignee: FUJI ELECTRIC CO., LTD., Kawasaki-shi (JP)

(21) Appl. No.: 18/588,437

(22) Filed: Feb. 27, 2024

Related U.S. Application Data
(63) Continuation of application No. PCT/JP2023/007629, filed on Mar. 1, 2023.

(30) Foreign Application Priority Data
Apr. 1, 2022 (JP) 2022-061967

(51) Int. Cl. C23F 14/02

(52) U.S. Cl. CPC C23F 14/02

(57) ABSTRACT

A method for selecting chemical agents for removing scale, the chemical agents being adapted for scale and its base material. A method for selecting chemical agents for removing scale, the method including steps of: obtaining coordinates A of an intrinsic physical property value based on a Hansen solubility parameter of an entire scale of interest; obtaining coordinates B of an intrinsic physical property value based on a Hansen solubility parameter of a surface on a base material side of the scale of interest; obtaining coordinates C of an intrinsic physical property value based on a Hansen solubility parameter of a base material of interest; selecting a penetrant having coordinates D of an intrinsic physical property value based on a Hansen solubility parameter based on an interaction radius Ra of the scale of interest with the coordinates A at the center; selecting a remover having coordinates E of an intrinsic physical property value based on a Hansen solubility parameter based on a positional relationship between the coordinates B and the coordinates C; and selecting an inducer having coordinates F of an intrinsic physical property value based on a Hansen solubility parameter based on a positional relationship between the coordinates D and the coordinates E.

### CROSS-REFERENCE TO RELATED APPLICATIONS

This application is continuation application of PCT/JP2023/007629, filed on Mar. 1, 2023, which claims priority to Japanese Patent Application No. 2022-061967, filed on Apr. 1, 2022, the contents of all of which are incorporated herein by reference.

### TECHNICAL FIELD

The present invention relates to a method for selecting chemical agents for removing scale and to a method for removing scale.

### BACKGROUND ART

Conventionally, scale adhesion has been a problem in systems including fluid distribution systems such as power generation plant systems, ship systems, boiler systems, and steel plant systems.

Various chemical agents and devices have been used to remove scale. For example, as chemical agents for dissolving and cleaning silica scale in geothermal power generation, oxidizing agents such as hydrofluoric acid, acetic acid, sulfuric acid, and hydrochloric acid and alkaline agents such as sodium hydroxide, sodium carbonate, and sodium bicarbonate have been used from experience. These chemical agents have been used in a method that causes a chemical reaction with a compound that forms scale and dissolves it from the surface layer.

A device for removing scale of steam turbines for geothermal power generation configured to inject steam having a pressure boosted to a predetermined pressure toward the surface of a nozzle and/or a blade disposed in a steam turbine for geothermal power generation is known (for example, see Patent Document 1). Furthermore, there is known a scale removal agent containing tropolones, optionally and selectively containing at least one of hydrochloric acid, sulfuric acid, and nitric acid, and having a pH adjusted to 1 to 2 (for example, see Patent Document 2).

### REFERENCE DOCUMENT LIST

### Patent Documents

Patent Document 1: JP 2005-220850 A
Patent Document 2: JP 2013-202424 A

### SUMMARY OF THE INVENTION

### Problem to be Solved by the Invention

Among plant systems in which scale is a problem, the concentration of silica dissolved in geothermal water flowing inside geothermal power generation plants is high. For example, while the concentration of silica dissolved in cooling water is about 150 ppm at maximum, the concentration of silica dissolved in geothermal water in Japan reaches as high as 450 to 900 ppm. Therefore, there has been a problem that scale such as amorphous silica is likely to precipitate, which has been a problem.

Furthermore, the silica scale component varies greatly depending on the power plant. This is considered to be because of the differences in metals dissolved in geothermal water, but it has been difficult to select an optimal scale inhibitor in each power plant.

Conventionally, scale removal by oxidizing agents or alkaline agents, which has been widely used, has been a method that involves a chemical reaction. This resulted in problems such as unexpected precipitates (reaction products), poor cleaning, and generation of harmful gases. It is desirable to select optimal chemical agents according to the scale component of each plant.

### Means for Solving the Problem

The inventors have researched selecting chemical agents for removing scale based on Hansen solubility parameters (HSP) and Hansen solubility spheres, in order to select chemical agents for removing scale according to the scale component. In particular, focusing not only on the surface scale composition, but also on the scale composition of the area in contact with a base material and the composition of the base material, they came up with the idea of selecting chemical agents for removing scale from the perspective of weakening the adhesion force at the scale adhesion interface, thereby accomplishing the present invention.

That is, according to one embodiment, the present invention is a method for selecting chemical agents for removing scale, the method including steps of: obtaining coordinates A of an intrinsic physical property value based on a Hansen solubility parameter of an entire scale of interest: obtaining coordinates B of an intrinsic physical property value based on a Hansen solubility parameter of a surface on a base material side of the scale of interest: obtaining coordinates C of an intrinsic physical property value based on a Hansen solubility parameter of a base material of interest; selecting a penetrant having coordinates D of an intrinsic physical property value based on a Hansen solubility parameter based on an interaction radius Ra of the scale of interest with the coordinates A at the center; selecting a remover having coordinates E of an intrinsic physical property value based on a Hansen solubility parameter based on a positional relationship between the coordinates B and the coordinates C; and selecting an inducer having coordinates F of an intrinsic physical property value based on a Hansen solubility parameter based on a positional relationship between the coordinates D and the coordinates E.

In the method for selecting chemical agents for removing scale, it is preferable that, when the coordinates of the intrinsic physical property values are represented by three-dimensional coordinates composed of a dispersion force δD, a dipole force δP, and a hydrogen bonding force δH, and when the coordinates A are referred to as (δDA, δPA, δHA), the coordinates D are referred to as (δDD, δPD, δHD), and the interaction radius is referred to as Ra, the step of selecting a penetrant is selecting a material having coordinates D satisfying formula (I) below: 4(δDA−δDD)\hat{ }2+(δPA−δPD)\hat{ }2+(δHA−δHD)\hat{ }2≤(Ra)\hat{ }2 (I) as the penetrant.

In the method for selecting chemical agents for removing scale, it is preferable that, when the coordinates B are referred to as (δDB, δPB, δHB), the coordinates C are referred to as (δDC, δPC, δHC), the coordinates E are referred to as (δDE, δPE, δHE), and the interaction radius is referred to as Ra, the step of selecting a remover be selecting a material having coordinates E falling within an area represented by the locus of a sphere with the center on a line segment BC and with a radius Ra based on the Hansen solubility sphere and satisfying formula (II) below: (δDB, δPB, δHB)≤(δDE, δPE, δHE)≤(δDC, δPC, δHC) or (δDB, δPB, δHB)>(δDE, δPE, δHE)>(δDC, δPC, δHC) (II) as the remover.

In the method for selecting chemical agents for removing scale, it is preferable that, when the coordinates F are referred to as (δDF, δPF, δHF), and the interaction radius is referred to as Ra, the step of selecting an inducer be selecting a material having coordinates F falling within an area represented by the locus of a sphere with the center on a line segment DE and with a radius Ra based on the Hansen solubility sphere and satisfying formula (III) below: (δDD, δPD, δHD)≤(δDF, δPF, δHF)≤ (δDE, δPE, δHE) or (δDD, δPD, δHD)>(δDF, δPF, δHF)>(δDE, δPE, δHE) (III) as the inducer.

According to another embodiment, the present invention relates to a method for removing scale, including steps of: selecting a penetrant, an inducer, and a remover based on any one of the aforementioned selection methods; and applying the penetrant, the inducer, and the remover selected by the aforementioned selection step to the scale of interest in this order or substantially simultaneously.

The method for removing scale preferably further includes a step of applying a physical force to the scale of interest and/or a step of applying a corrosion inhibitor to the scale of interest.

According to yet another embodiment, the present invention relates to a method for removing scale in a geothermal power generation system, the method including steps of: selecting, for each of a plurality of devices constituting the geothermal power generation system, a penetrant, an inducer, and a remover for the device based on any one of the aforementioned selection methods; and applying, for each of the plurality of devices, the penetrant, the inducer, and the remover selected by the aforementioned selection step to the scale of interest in this order or substantially simultaneously.

### Effects of the Invention

The method for selecting chemical agents for removing scale according to the present invention enables a combination of chemical agents, generally having different functions, which are a penetrant, an inducer, and a remover, to be selected in consideration of the scale of interest, a base material to which the scale adheres, and the scale composition at the interface with the base material using HSP technique. Therefore, it is possible to select an optimal combination of chemical agents for plants in which scale adhesion is a problem and/or an optimal combination of chemical agents for scale adhesion sites within the same plant. Since it is possible to decompose and remove scale with substantially no chemical changes by the selection method according to the present invention, focusing on the adhesion at the interface, precipitate formation and poor cleaning can be reduced. As a result, the machine cleaning period in the subsequent step can be reduced. Furthermore, since it is possible to select a combination of chemical agents from a plurality of options using HSP technique, dangerous chemical agents such as hydrofluoric acid, which have been commonly used, can be excluded. Therefore, the risk of generating harmful gases can be avoided, and the disposal of industrial waste can also be simplified.

### BRIEF DESCRIPTION OF THE DRAWINGS

FIG. 1 is a diagram for illustrating an example of a method for selecting chemical agents for removing scale according to a first embodiment of the present invention, the diagram conceptually showing the coordinates of intrinsic physical property values of the entire scale, the surface on a base material side of the scale, the base material, a penetrant, an inducer, and a remover based on the Hansen solubility parameters.

FIG. 2 is a diagram conceptually showing a cylinder that serves as the selected area when selecting a remover based on the coordinates of the surface on the base material side of the scale and the base material.

FIGS. 3A, 3B, 3C, and 3D are diagrams conceptually showing the mechanism to remove scale when applying the penetrant, the inducer, and the remover, in this order, to the scale and the base material in the method for removing scale according to a third embodiment of the present invention.

FIG. 4 is a diagram conceptually showing an example of a geothermal power generation system to which the method for removing scale according to a fourth embodiment of the present invention is applied.

### MODE FOR CARRYING OUT THE INVENTION

Hereinafter, the embodiments of the present invention will be described with reference to drawings. However, the present invention is not limited by the following embodiments described below.

### First Embodiment: Method for Selecting Chemical Agents for Removing Scale

According to a first embodiment, the present invention relates to a method for selecting chemical agents for removing scale. The selection method includes the following steps:
(1) obtaining coordinates A of an intrinsic physical property value based on a Hansen solubility parameter of the entire scale of interest;
(2) obtaining coordinates B of an intrinsic physical property value based on a Hansen solubility parameter of a surface on a base material side of the scale of interest;
(3) obtaining coordinates C of an intrinsic physical property value based on a Hansen solubility parameter of the base material of interest;
(4) selecting a penetrant having coordinates D of an intrinsic physical property value based on a Hansen solubility parameter based on an interaction radius Ra of the scale of interest with the coordinates A at the center;
(5) selecting a remover having coordinates E of an intrinsic physical property value based on a Hansen solubility parameter based on a positional relationship between the coordinates B and the coordinates C; and
(6) selecting an inducer having coordinates F of an intrinsic physical property value based on a Hansen solubility parameter based on a positional relationship between the coordinates D and the coordinates E.

The chemical agents for removing scale in the present invention are selected in order to remove specific scale adhering on a specific base material in facilities in which scale adhesion is of concern, such as plants. Hereinafter, a specific site in which scale adheres and requires removal will be referred to an adhesion site. Furthermore, the material of the surface in which scale adheres such as devices in such facilities will be referred to as a base material of interest, and scale adhering will be referred to as scale of interest.

In the present invention, chemical agents for removing scale refer to chemical agents used for removing scale, typically, a combination of chemical agents composed of three types of chemical agents, a penetrant, an inducer, and a remover selected by the method of this embodiment. The penetrant functions to penetrate into the entire scale, form cracks in the scale, and promote the formation of a path from the surface of the scale through the inside of the scale to the interface with the base material. The inducer functions to promote the introduction of the remover using the path to the interface formed by the penetrant. The remover is a chemical agent having high affinity with the scale adhesion surface so as to function to reduce the adhesion of the scale to the base material by penetrating into the fixed part. Generally, separate and different chemical agents are selected as the penetrant, the inducer, and the remover constituting the chemical agents for removing scale. However, any two or all of the penetrant, the inducer, and the remover may be the same material, as a result of selection of the chemical agents for removing scale depending on the compositions of the scale and the base material.

The penetrant, the inducer, and the remover may each be a chemical agent composed of one type of material, or may be a mixture of two or more types of materials. A penetrant consisting of a single material is also referred to herein as a single penetrant. A penetrant composed of a mixture of two or more materials is also referred to as a mixed penetrant. Likewise, the inducer may be a single inducer or a mixed inducer, and the remover may be a single remover and a mixed remover.

The scale of interest may be any scale that can contain an inorganic compound and an organic compound. More specifically, it may be scale that is generated and adheres derived from the materials dissolved in a fluid material such as circulating water in power generation plant systems such as geothermal, thermal, nuclear, hydropower, or biomass, ship systems such as ship exhaust gas purification systems (EGCS: Exhaust Gas Cleaning Systems) and seawater desalination systems, and steel plant systems such as factory heating heat sources, boiler systems for building heating and hot water supply, cooling water systems, and water washing systems, and the type thereof is not particularly limited. For example, in a geothermal power generation plant, it may be scale composed of multiple components generated in layers on a base material such as pipes, heat exchangers, turbines, and drains constituting the plant.

The intrinsic physical property values based on Hansen solubility parameters are based on three-dimensional coordinates composed of three intrinsic physical property values of dispersion force δD, dipole force δP, and hydrogen bonding force δH. Hereinafter, the coordinates of intrinsic physical property values based on Hansen solubility parameters will be abbreviated as the HSP coordinates.

### (1) Step of Obtaining HSP Coordinates a of Entire Scale of Interest

In the first step, HSP coordinates A of the entire scale of interest are obtained. The “HSP coordinates of the entire scale of interest” are the HSP coordinates generally reflecting characteristics when scale compositions as natural products or by-products that are various compounds non-uniformly stacked are averaged. For HSP coordinates A of the entire scale of interest, values reported in databases or literature may be used in some cases, but generally they can be obtained by scale dissolution experiments.

The scale dissolution experiments can be performed, for example, as follows. The scale used for dissolution experiments can be collected from a target site such as a plant to which the selected chemical agents are applied. When collecting scale, it is preferable to collect the scale while maintaining the shape from the fluid contact surface to the base material contact surface of the scale. For example, it is preferable to collect 50 g or more of scale by dry weight for analysis. However, even if the shape is distorted, each interface part can be identified by microscopic observation, and even if the weight is low, analysis to obtain the HSP coordinates of the entire scale of interest is possible by using it together with compositional analysis. Next, a plurality of solvents with known HSP coordinates are prepared, a predetermined amount of the collected scale is added to each solvent, and it is confirmed whether or not the scale is dissolved in the solvent. A particle size distribution meter, the weight of the residue after filtration, and differential thermogravimetric analysis (TG-DTA) of the solvent after addition of the scale are preferably used for the criteria for determining whether or not the scale is dissolved in a solvent, but determination by visual observation is also possible. The Hansen solubility parameters for chemical agents such as solvents can be obtained from databases. Furthermore, if the structure of a material is known, the Hansen solubility parameters of the material can be obtained using Hansen solubility parameter software HSPiP (Hansen Solubility Parameters in Practice). Then, the HSP coordinates of multiple solvents that have been determined to dissolve the scale are plotted on a three-dimensional coordinate space, and coordinates at the center of the sphere composed of these coordinates can be referred to as HSP coordinates A (δDA, δPA, δHA) of the entire scale of interest. The step of extrapolating the sphere based on the data of the plurality of coordinates and determining the center coordinates can be performed using a commercially available software, for example, the same HSPiP as described above.

### (2) Step of Obtaining HSP Coordinates B of Surface on Base Material Side of Scale of Interest

In the second step, HSP coordinates B of the surface on the base material side of the scale of interest are obtained. The surface on the base material side of the scale of interest refers to a portion corresponding to the interface in contact with the base material of the scale of interest. HSP coordinates B of the surface on the base material side of the scale of interest can be obtained by analytic experiments of the interface of the scale.

The analytic experiments on the interface of the scale can be performed, for example, as follows. Scale is grown on a test piece composed of the same material as the base material of interest using a fluid with the same composition as the fluid circulating through the adhesion site of the scale of interest. Then, a cross section of the scale grown on the test piece is observed using a scanning electron microscope-energy dispersive X-ray spectroscopy (SEM-EDX), and the (local) composition of the interface is specified. The local composition of the interface refers to an area in which the depth from the interface is approximately several tens to several hundreds of nm, for example, approximately 10 nm to 900 nm. Once the local composition of the interface is specified, coordinates B (δDB, δPB, δHB) can be specified by referring to an inorganic HSP database that has been separately constructed. More specifically, elements and their composition ratios are obtained by SEM-EDX, and compounds and their composition ratios are estimated. Next, the HSP coordinates of each compound is obtained by referring to the database, and HSP coordinates B of the surface on the base material side of the scale of interest can be obtained according to the method for obtaining the HSP coordinates of a mixture, described later.

### (3) Step of Obtaining HSP Coordinates C of Base Material of Interest

In the third step, HSP coordinates C of the base material of interest are obtained. HSP coordinates C of the base material of interest are the HSP coordinates of the uppermost surface of the base material. Accordingly, even if the site to which scale adheres is a pipe, and the pipe itself is made of steel, the HSP coordinates of the coated surface is obtained when a coating is provided on the surface. For HSP coordinates C of the base material of interest, values reported in databases or literature may be used in some cases, but generally they can be obtained by the HSP analysis of the surface of the base material using a contact angle method.

In the contact angle method, a plurality of solvents having known HSP coordinates are prepared in the same manner as in the first step. These solvents are titrated against the base material of interest and the contact angle (wettability) is measured. Criteria for determining whether the wettability is good or poor differ depending on the material and can be appropriately determined by those skilled in the art depending on the material. For example, for metal-based materials, wettability can be considered good when the contact angle θ is 20° or less, and poor when it exceeds 20°. Next, the HSP coordinates of the plurality of solvents determined to have good wettability are plotted on a three-dimensional coordinate space, and the coordinates of the center of the sphere composed of these coordinates is referred to as HSP coordinates C (δDC, δPC, δHC) of the base material of interest.

Steps (1) to (3) above are referred to as the first, second, and third steps for convenience of explanation, but these steps can be performed independently in any order.

### (4) Step of Selecting Penetrant Having HSP Coordinates D

The fourth step is a step of selecting a penetrant having the HSP coordinates D and is a step of selecting a penetrant based on HSP coordinates A of the entire scale of interest. A material having high affinity with the entire scale of interest is selected as the penetrant. More specifically, when coordinates D of the penetrant are referred to (δDD, δPD, δHD), and the interaction radius thereof is referred to Ra, a material having coordinates D satisfying formula (I) below is selected as the penetrant, in relation to coordinates A obtained in the first step.

$$4 ( δ DA - δ DD ) \hat{} 2 + ( δ PA - δ PD ) \hat{} 2 + ( δ HA - δ HD ) \hat{} 2 \leq {( Ra )}^{∧} 2 \qquad ( I )$$

Here, interaction radius Ra is a numerical value representing the range of materials that have affinity for a material having certain HSP coordinates, and interaction radius Ra can be determined depending on the purpose and application. It can be said that the smaller interaction radius Ra of a material having certain HSP coordinates, the greater the interaction. The upper limit of Ra is preferably small, but it may be, for example, about 5 (MPa^{1/2}) depending on the intended specifications, or may be 4.5, 4, 3.5, 3, 2.5, or 2 or less.

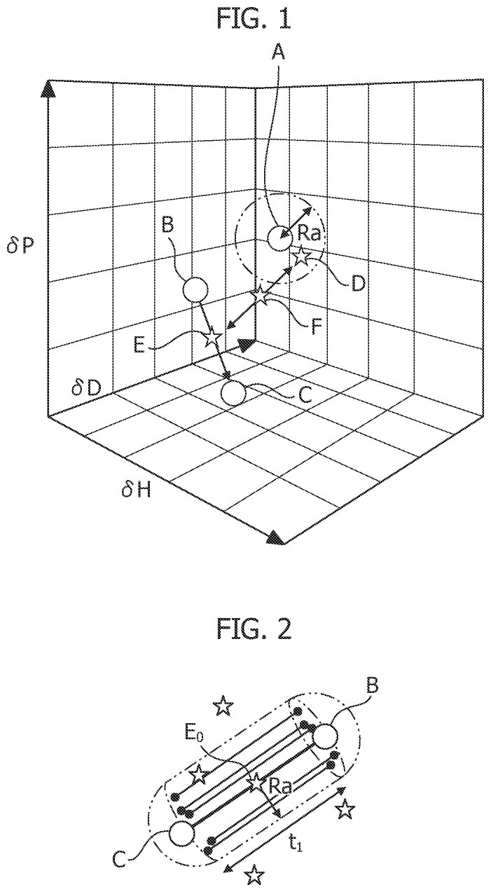

FIG. 1 is a diagram conceptually showing the HSP three-dimensional coordinate space in which the selection method according to the present embodiment is implemented. In the figure, A represents the HSP coordinates of the entire scale of interest, and a sphere having interaction radius Ra is shown by an imaginary line with coordinates A at the center. At this time, the penetrant is a material having coordinates D and can be said to be a material having coordinates on the spherical surface and inside the sphere. If a plurality of suitable candidate materials exist, it is preferable to select a material having coordinates closer to coordinates A as the penetrant. However, the penetrant can be selected in consideration of not only the distance between coordinates A and D, but also handleability and cost of the material.

Here, the material is not limited to a material that exists alone as a compound, but it also includes a part of a compound such as a monomer (repeating unit) that can form a polymer and a modifying group. The HSP coordinates of such a single compound, monomer, or material containing a modifying group can be selected from known materials in databases, literature, and the like, for example. In conventional technology, chemical agents that remove scale have been selected from known compounds, but it is now possible to select more appropriate materials from a wider selection of monomers and functional groups by using HSP technique, which is advantageous.

A mixed penetrant containing a mixture of two or more materials can also be selected. The HSP coordinates of the mixture can generally be expressed as the sum of the molar fractions of the HSP coordinates of its constituent materials. For example, the HSP coordinates of a mixture of a first material x (mol %) and a second material y (mol %), when the HSP coordinates of the first material are referred to as m₁ (δDm₁, δPm₁, δHm₁), and the HSP coordinates of the second material are referred to as m₂ (δDm₂, δPm₂, δHm₂), can be expressed as follows. Here, x+y=100 (mol %).

$$\{ ( δ {Dm}_{1} \times x / 100 + δ {Dm}_{2} \times y / 100 ) , \\ ( δ {Pm}_{1} \times x / 100 + δ {Pm}_{2} \times y / 100 ) , ( δ {Hm}_{1} \times x / 100 + δ {Hm}_{2} \times y / 100 ) \}$$

Accordingly, when the HSP coordinates of the mixture satisfy Formula (I) above, the mixed penetrant can be handled and selected in the same manner as in a penetrant as a single material. Likewise, the HPS coordinates of three or four or more types of mixtures can also be obtained by the sum of the HSP coordinate values of each constituent material multiplied by the mole fraction.

The fourth step can be performed after the determination of coordinates A in the first step regardless of the second and third steps in no particular order. Furthermore, it can be performed regardless of the fifth step, which will be described below, in no particular order, independently.

### (5) Step of Selecting Remover Having HSP Coordinates E

The fifth step is a step of selecting a remover having HSP coordinates E based on a positional relationship between the coordinates B and the coordinates C. The remover can be selected from materials having an HSP that is intermediate values between the HSP of the surface on the base material side of the scale and the HSP of the base material of interest. Specifically, when coordinates E of the remover are referred to as (δDE, δPE, δHE), and an interaction radius is referred to as Ra, a material having coordinates E that are within the area represented by the locus of a sphere with a radius Ra and with the center on a line segment BC and satisfy formula (II) below is selected as the remover, in relation to coordinates B obtained in the second step and coordinates C obtained in the third step.

$$( δ DB , δ PB , δ HB ) \leq ( δ DE , δ PE , δ HE ) \leq ( δ D C , δ PC , δ HC ) \qquad ( II )$$

$$or ( δ DB , δ PB , δ HB ) > ( δ DE , δ PE , δ HE ) > ( δ D C , δ PC , δ HC )$$

The selection of coordinates E that satisfy the aforementioned conditions and formula (II) above will be further described with reference to FIG. 1 and FIG. 2. In FIG. 1, B represents the HSP coordinates of the surface on the base material side of the scale, and C represents the HSP coordinates of the base material of interest. At this time, coordinates E are selected from an area represented by the locus of a sphere with the center on the line segment connecting B with C and with radius Ra. In other words, coordinates E are selected from the surface and inside of an area in which a hemisphere with a radius of Ra is added to the two bottom surfaces of a cylinder with line segment BC at the center axis and radius Ra. The area discussed under these conditions is Hansen's three-dimensional space, and the ratio of the graph to the axis is different from that of a normal three-dimensional space, and is D:P:H=1/2:1:1. Accordingly, in the formula representing the sphere, a coefficient of 2 is added to the axis ratio of the term of dispersion force δD based on the Hansen solubility sphere. The selection range of the release agent will be explained below in more detail using mathematical formulas.

FIG. 2 is a conceptual diagram of an area assumed in the HSP three-dimensional coordinate space when selecting a remover. In FIG. 2, B and C respectively represents coordinates B and C, showing the area assumed by an imaginary line. Ra is the radius of a cylinder with the center axis on a line segment BC, and the star marks represent materials having coordinates in the periphery of the cylinder. Here, coordinates E₀ on a line segment BC can be expressed by Formula (a) below.

$$( δ {DE}_{0} , δ {PE}_{0} , δ {HE}_{0} ) = ( δ DB , δ PB , δ HB ) + {t}_{1} \{ ( δ D C - δ DB ) , ( δ PC - δ PB ) , ( δ HC - 6 HB ) \} \qquad ( a )$$

In Formula (a), 0≤ t₁≤1. Here, the coordinates on the surface of a sphere with coordinates E₀ at the center and radius Ra or inside the sphere can be represented by Formula (b) below based on the Hansen solubility sphere.

$$Ra \hat{} 2 \geq 4 ( δ {DE}_{0} - δ DE ) \hat{} 2 + ( δ {PE}_{0} - δ PE ) \hat{} 2 + ( δ {HE}_{0} - δ HE ) \hat{} 2 \qquad ( b )$$

In Formula (a), since t₁ varies from 0 to 1, the area from which coordinates E of the remover can be selected is expressed by the locus of the sphere with radius Ra.

When the distance from E₀ in the coordinates n (δDn, δPn, δHn) inside the area is referred to as R(n), R(n)/Ra=RED (Relative Energy Difference) is satisfied, and coordinates n for which RED is 1 or less are selected. A value used in formula (I) of the fourth step can be employed as Ra. When a plurality of candidate materials exist as coordinates E of the remover satisfying formula (b) above, it is preferable to select a material with t₁ close to 0.5 and R(n) close to 0. Even if the values of t₁ and R(n) satisfy the conditions, it is also possible to exclude certain materials from the materials to be selected in view of the cost and safety of the materials to be selected.

Next, a specific selecting procedure will be described. First, the coordinates of a remover with t₁=0.5 are set as the recommended coordinates, and the recommended coordinates E₀ are determined. Then, a sphere is searched for based on Formula (c) below.

$$R ( n ) \hat{} 2 = 4 ( δ {DE}_{0} - δ Dn ) \hat{} 2 + ( δ {PE}_{0} - δ Pn ) \hat{} 2 + ( δ {HE}_{0} - δ Hn ) \hat{} 2 \qquad ( c )$$

A material having the coordinates n for which RED is 1 or less is extracted with reference to the values in a database. If there are a plurality of applicable materials, a material with smaller RED is selected as the remover having coordinates E. When no materials are applicable to those having coordinates n for which RED is 1 or less, the value t₁ is changed to t₁=0.5±δ, E₀ is determined in the same manner as above, and a material having coordinates n is extracted based on Formula (c). That is, a sphere with the center shifted by δ toward coordinates B and a sphere with the center shifted by δ toward coordinates C from the recommended coordinates are searched. The value of 8 can be, for example, 0.05 and is not limited to a specific numerical value. When no materials are usable, this operation is repeated, and finally, it is possible to search for an area represented by the locus of a sphere with the center on the line segment connecting B and C with radius Ra. In addition, when selecting the remover, a mixed remover in which two or three or more types of materials are mixed can be selected based on the method for calculating the HSP coordinates of the aforementioned mixture.

In Formula (II), for example, when the base material is a metal, the coordinates of the remover can be generally selected so as to satisfy the relationship of the former formula, and when the base material is glass, the coordinates of the remover can be generally selected so as to satisfy the relationship of the latter formula.

The fifth step can be performed after the determination of coordinates B and C in the second and third steps in no particular order, regardless of the first and fourth steps, independently.

### (6) Step of Selecting Inducer Having HSP Coordinates F

The sixth step is a step of selecting an inducer having HSP coordinates F based on the positional relationship between the coordinates D and the coordinates E. A material having high affinity with the two of the penetrant and the remover is selected as the inducer. Specifically, when coordinates F of the inducer are referred to as (δDF, δPF, δHF), and the interaction radius is Ra, a material having coordinates F satisfying the conditions of formula (III) below inside an area represented by the locus of a sphere with the center on a line segment DE and with radius Ra, in relation to coordinates D obtained in the fourth step and coordinates E obtained in the fifth step, is selected as the inducer.

$$( δ DD , δ PD , δ HD ) \leq ( δ DF , δ PF , δ H F ) \leq ( δ DE , δ PE , δ HE ) \qquad ( III )$$

$$or ( δ DD , δ PD , δ HD ) > ( δ DF , δ PF , δ H F ) > ( δ DE , δ PE , δ HE )$$

The step of selecting coordinates F satisfying the conditions and Formula (III) above is substantially the same as in the fifth step. It will be further described with reference to FIG. 1. In FIG. 1, D represents the HSP coordinates of the penetrant, and E represents the HSP coordinates of the remover. At this time, coordinates F are selected from an area having the center on the line segment connecting D and E and represented by the locus of a sphere with radius Ra. In other words, coordinates F are selected from the surface and the inside of an area having the center axis on a line segment DE, in which a hemisphere with a radius Ra is added to the two bottom surfaces of a cylinder with radius Ra.

Also in this step, a selected area can be assumed in the HSP three-dimensional coordinate space in the same manner as in FIG. 2 (not shown). Here, coordinates F₀ of a point on a line segment DE can be represented by Formula (d) below.

$$( δ {DF}_{0} , δ {PF}_{0} , δ H {F}_{0} ) = ( δ DD , δ PD , δ HD ) + {t}_{2} \{ ( δ DE - δ DD ) , ( δ PE - δ PD ) , ( δ HE - δ HD ) \} \qquad ( d )$$

In Formula (d), 0≤ t₂≤1. Here, coordinates F on the surface of the sphere or inside the sphere with coordinates F₀ at the center and radius Ra can be represented by Formula (e) below based on the Hansen solubility sphere.

$$Ra \hat{} 2 \geq 4 ( δ {DF}_{0} - δ DF ) \hat{} 2 + ( δ {PF}_{0} - δ PF ) \hat{} 2 + ( δ H {F}_{0} - δ H F ) \hat{} 2 \qquad ( e )$$

In Formula (d), since t₂ varies from 0 to 1, the area from which coordinates F of the inducer can be selected is represented by the locus of the sphere with radius Ra.

In the same manner as in the fifth step, the distance from F₀ is referred to R(n) in coordinates n (δDn, δPn, δHn) within the area, coordinates n for which RED is 1 or less is selected. A value used in formula (I) can be employed as Ra. When a plurality of candidate materials are present as coordinates F of the inducer satisfying Formula (d) above, a material having t₂ closer to 0.5 and R(n) closer to 0 is preferably selected. It is also possible to select an inducer in consideration of not only the values of t₂ and R(n), but also the cost and safety of the material.

The specific procedure of selection is also substantially the same as in the fifth step. First, the coordinates of the inducer with t₂=0.5 are referred to as recommended coordinates, and the F₀ of the recommended coordinates is determined. Then, a sphere is searched for based on Formula (f) below.

$$R ( n ) \hat{} 2 = 4 ( δ {DF}_{0} - δ Dn ) \hat{} 2 + ( δ {PF}_{0} - δ Pn ) \hat{} 2 + ( δ H {F}_{0} - δ Hn ) \hat{} 2 \qquad ( f )$$

The extraction method of coordinates can be performed in the same manner as in the fifth step. When no materials are usable to those having coordinates n for which RED is 1 or less, F₀ is determined for t₂=0.5±δ, and a material having coordinates n can be sequentially extracted based on Formula (f). Furthermore, also when selecting an inducer, a mixed inducer in which two or three or more types of materials are mixed can be selected.

In this way, three types of chemical agents, a penetrant, a remover, and an inducer can be selected by performing the first to sixth steps, so that efficient removal of scale is enabled using these chemical agents.

### Second Embodiment: Method for Producing Chemical Agents for Removing Scale

According to the second embodiment, the present invention relates to a method for producing chemical agents for removing scale. The production method includes the following steps: (a) selecting chemical agents for removing scale including a penetrant, an inducer, and a remover; and (b) preparing the penetrant, the inducer, and the remover separately or preparing a chemical agent combining any two or more of the penetrant, the inducer, and the remover.

Step (a) according to the present embodiment corresponds to the selection method according to the first embodiment. Therefore, step (a) can be performed by performing the first to sixth steps of the first embodiment.

In step (b) according to the present embodiment, the materials selected in step (a) are prepared so as to be available. When the penetrant, the inducer, and the remover are all compounds or a mixture in the case of using the penetrant, the inducer, and the remover individually without mixing, the penetrant, the inducer, and the remover can be prepared separately and packaged separately. In this case, the chemical agents for removing scale are a combination of a plurality of chemical agents and can be handled using a combination chemical or chemical kit.

When the penetrant, the inducer, and the remover are all compounds or a mixture, and their HSP coordinates are very close to each other, or any two or more of them are the same material, step (b) may be a step of mixing them to be packaged.

When any of the penetrant, the inducer, and the remover is a monomer or a modifying group, step (b) may be a step of preparing a copolymer or a step of preparing a single compound containing a modifying group.

According to the method for producing chemical agents for removing scale according to the second embodiment, chemical agents of suitable forms or a suitable combination chemical can be produced.

### Third Embodiment: Method for Removing Scale

According to the third embodiment, the present invention relates to a method for removing scale. The method for removing scale includes the following steps: (I) selecting a penetrant, an inducer, and a remover based on the selection method of the first embodiment; and (II) applying the penetrant, the inducer, and the remover selected in the selection step to the scale of interest in this order or substantially simultaneously.

As optional and selective steps, either or both of steps (III) and (IV) below may be further included: (III) applying a physical force to the scale of interest; and (IV) applying a corrosion inhibitor to the scale of interest.

Step (I) of the present embodiment can be performed by the method described in the first embodiment, and thus, description thereof is omitted herein.

In step (II), the penetrant, the inducer, and the remover selected in step (I) are prepared. For preparation of the penetrant, the inducer, and the remover, the method described in step (b) of the second embodiment can be performed.

In the case in which chemical agents are separately used as the penetrant, the inducer, and the remover, they are applied to the scale of interest in this order. The scale of interest may be scale that is estimated to have the composition used to determine coordinates A in the first embodiment.

Examples of the method for applying each chemical agent include spraying the chemical agent at the scale of interest, pouring the chemical agent into a device to which the scale of interest has adhered, bringing the chemical agent into contact with the scale of interest for a predetermined time, blowing the chemical agent on the scale of interest, and injecting the chemical agent into the scale of interest, but these examples are not limiting. Examples of the step of pouring the chemical agent into a device to which the scale of interest has adhered can include a method of filling the device with the chemical agent to circulate the chemical agent, a method of semi-opening the device and pouring the chemical agent, and a method of infusing the chemical agent with a liquid remaining. Examples of the step of bringing the chemical agent into contact can include a method of immersing the device or a part thereof in the chemical agent. Examples of the step of injecting the chemical agent to the scale of interest can include a method of dropping the chemical agent onto the scale.

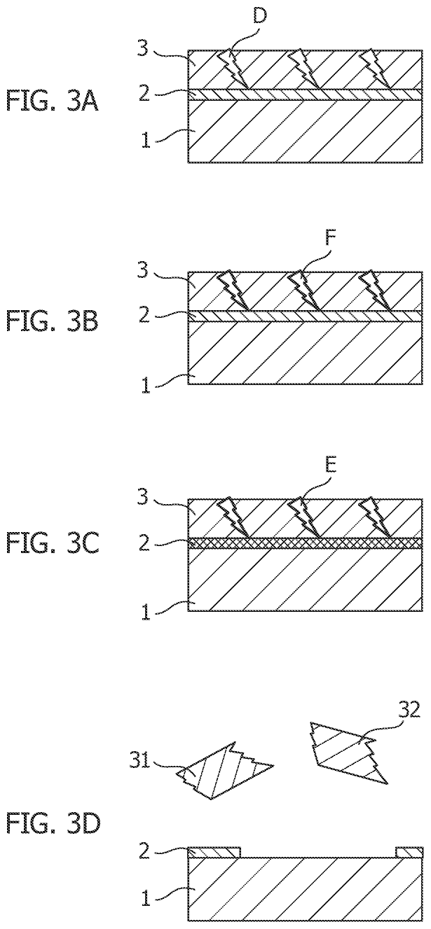

The functions of each chemical agent and the mechanism of scale removal will be described with reference to FIGS. 3A, 3B, 3C, and 3D. FIG. 3A is a schematic diagram showing the first stage of the removal method when a penetrant D is applied to scale 3 that has fixed on a base material 1. Penetrant D functions to penetrate entire scale 3 to generate cracks. FIG. 3B is a schematic diagram showing the second stage of the removal method when applying an inducer F after applying penetrant D. Inducer F is preferably applied after a lapse of a predetermined time from the application of penetrant D, and can be applied, for example, after a lapse of 1 to 3 hours, but there is no limitation to a specific time. Inducer F promotes the development of cracks generated by penetrant D, to reach a surface on the base material side 2 of the scale (interface between the scale and the base material). FIG. 3C is a schematic diagram showing the third stage of the removal method when applying a remover E after the application of inducer F. Remover E is preferably applied after a lapse of a predetermined time from the application of inducer F and can be applied, for example, after a lapse of 0.5 to 2 hours, but there is no limitation to a specific time. Remover E directly acts on the surface 2 on the base material side of the scale and has high affinity with a base material 1 to reach base material 1. FIG. 3D shows the fourth stage of the removal method, in which scale that was deposited together is decomposed due to the cooperative action of penetrant D, inducer F, and remover E and is peeled off from the surface of base material 1, to form scale pieces 31 and 32.

In another aspect, when preparing the penetrant, the inducer, and the remover as a mixture, and when preparing them as a copolymer or one compound, these can be applied substantially simultaneously to the scale. This application method may be advantageous since it reduces the effort required to manage each chemical agent individually and the complicated operation of applying each chemical agent individually, enabling the removal of the scale of interest in a single operation.

Step (III) that is an optional and selective step is a step of performing a method to cause a physical force to act on the scale and can be used in combination with the use of the penetrant, the inducer, and the remover. Chronologically, the physical method may be performed before the application of the penetrant or may be performed after the application of the remover. Alternatively, it is also possible to apply a physical force during the use of any or all of the penetrant, the inducer, and the remover substantially simultaneously. Preferably, the physical method can be performed after the remover is applied to the scale of interest.

Examples of the specific physical method include a step of causing a temperature change to the scale of interest to generate a shear force. In this step, a temperature change is applied to the base material and the scale, and the shear force generated due to the difference in linear expansion coefficient following the temperature change can cause cracks in the scale, thereby facilitating peeling. For example, a step of heating and cooling the scale and its peripheral materials can be performed. Heating and cooling can be repeated. These operations are advantageous in that the generated thermal stress can be maximized by imparting the temperature difference to the scale and its peripheral materials, preferably increasing the temperature difference. As the heating step, one or more means selected from a heater, induction heating (IH), microwave, burner, boiler steam, and hot air can be used. As the cooling step, one or more means selected from a chiller, river water, dry mist, and cold air can be used.

Other examples of the specific physical method include a step of applying a mechanical force to the scale of interest. In this step, the scale of interest can be subjected to mechanical works such as polishing, machining, peeling, drilling, hitting (jet cleaning or sandblasting), vibrating (vibrator or ultrasonic), cutting, peeled off, and/or crushing. A plurality of different physical methods can be used in combination, and the physical methods are not limited to examples shown herein.

Step (IV) that is an optional and selective step is a step of applying a corrosion inhibitor to the scale of interest. The corrosion inhibitor is a chemical agent that is mainly added to prevent corrosion caused by oxidation (rust formation) on a metal surface due to contact of oxygen with the metal surface and may be a commercially available chemical agent. For example, coating materials such as silicate-based, phosphate-based, amine-based, and oxidizing agent-based, and oxygen absorbent corrosion inhibitors such as iron powder-based and organic material-based such as L-ascorbic acid (vitamin C) can be used. Chronologically, corrosion inhibitors can be applied at any time when performing the removal method, and more preferably, be applied after the completion of cleaning.

According to the scale removal method of the present embodiment, scale adhesion is reduced, and scale can be removed effectively, economically, and safely by applying a combined chemical agent of the penetrant, the inducer, and the remover selected depending on the scale of interest in a predetermined order. Conventional scale removal using oxidizing agents and alkaline agents generates harmful gases and is a dangerous operation, but in the present invention, scale removal is performed using a dissolution reaction that does not substantially involve chemical reactions, so that safe work is possible.

### Fourth Embodiment: Method for Removing Scale in Geothermal Power Generation System

According to the fourth embodiment, the present invention relates to a method for removing scale in a geothermal power generation system. The method for removing scale in a geothermal power generation system includes the following steps of: (i) selecting, for each of a plurality of devices constituting the geothermal power generation system, a penetrant, an inducer, and a remover for the device based on the selection method of the first embodiment; and (ii) applying, for each of the plurality of devices, the penetrant, the inducer, and the remover selected by the selection step to the scale of interest in this order or substantially simultaneously.

The selection in step (i) can be performed by the method described in the first embodiment. The plurality of devices constituting the geothermal power generation system are not particularly limited and may be any devices in which scale adhesion is a concern or a problem in the system. The specific method or chronological order of application of the penetrant, the inducer, and the remover in step (ii), a step of applying a physical force to the scale of interest and a step of applying a corrosion inhibitor to the scale of interest, which may be optionally and selectively performed, can be performed by the method described in the third embodiment.

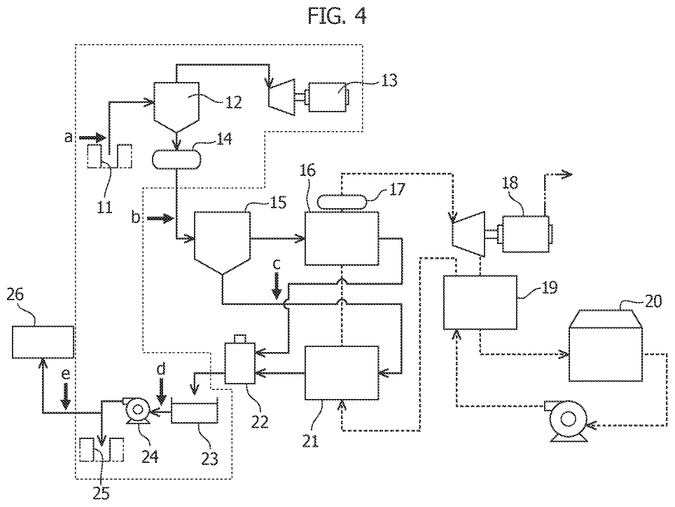

The plurality of devices constituting the geothermal power generation system in step (i) will be described with reference to FIG. 4. FIG. 4 is a conceptual flowchart showing an example of a binary cycle-type geothermal power generation system. The geothermal power generation system can be constituted by a production well 11, a first steam separator 12, a first turbine/power generator 13, a hot water tank 14, a second steam separator 15, an evaporator 16, a separator 17, a second turbine/power generator 18, a supply liquid heater 19, an air-cooled condenser 20, a preheater 21, a flash tank 22, a hot water pit 23, a reduction pump 24, and an injection well 25. Optionally and selectively, a facility 26 for post-heat utilization may be included. In FIG. 4, the flow of geothermal water is shown by solid arrows, and the flow of low boiling point medium is shown by dashed arrows. Furthermore, the area surrounded by a broken line indicates a flash power generation area.

The flow of materials in the geothermal power generation system will be briefly explained. Production well 11 is a well that brings hot water, steam, or a mixture thereof (geothermal water) from a geothermal reservoir underground to the ground. Geothermal water drawn from production well 11 is separated into steam, which is a gaseous component, and hot water, which is a liquid component, in first steam separator 12. The separated steam is guided to first turbine/power generator 13 and is used for rotating the turbine, causing the generator to produce electricity. The steam that has passed through first turbine/power generator 13 is cooled by a condenser (not shown) and guided to injection well 25 through piping (not shown). In addition, hot water that has been separated in first steam separator 12 is guided to second steam separator 15, passing through hot water tank 14. The gaseous component that has been separated in second steam separator 15 is guided to evaporator 16 and is used in evaporator 16 for heating the low boiling point solvent. The hot water liquefied again by heating the low boiling point solvent is then guided to flash tank 22. The liquid component that has been separated in second steam separator 15 is guided to the preheater 21 for heating the low boiling point medium and then guided to flash tank 22. In flash tank 22, the pressure of the hot water is reduced, and the generated water vapor is released into the atmosphere. The remaining liquid component after the pressure reduction is guided to hot water pit 23 and partially returned to injection well 25 and partially guided to facility 26 for post-heat utilization such as hot spring facilities by reduction pump 24.

As shown by the dashed arrows, the low boiling point medium is circulated in the facility. The low boiling point medium is heated by geothermal steam in evaporator 16, and the low boiling point medium in the two-phase flow is separated into a gas phase and a liquid phase in the separator 17. The low boiling point medium in the gas phase is guided to the second turbine/power generator 18. The low boiling point medium used for rotating the second turbine/power generator 18 is condensed in the supply liquid heater 19 to be liquefied, followed by heat emission in the condenser 20, and guided to the preheater 21. In the preheater 21, the liquefied low boiling point medium is heated again by geothermal water and is circulated in evaporator 16.

When selecting chemical agents for removing scale in this embodiment, non-limiting examples of scale of interest attachment sites are shown by the arrows in FIG. 1. Examples thereof include one or more sites of a device at or near the arrow a immediately after the fumes are emitted from production well 11, a device at or near the arrow b toward second steam separator 15 via first steam separator 12, a device at or near the arrow c toward the preheater 21 via second steam separator 15, a device at or near the arrow d toward reduction pump 24 from hot water pit 23, and a device at or near the arrow e of the medium sent to facility 26 for post-heat utilization by reduction pump 24. The devices can include pipes, valves, measuring instruments, tanks, heat exchangers, or any other devices. Even within the same geothermal power generation system, these sites may have different amounts and compositions of scale adhering depending on the composition and temperature of the fluid in contact therewith and the piping material. Accordingly, an optimal method for removing scale adopted for each device is enabled by determining coordinates A, B, and C in each device to obtain an optimal combination of a penetrant, an inducer, and a remover.

The method for removing scale according to the present embodiment can be performed, typically, while the geothermal power generation system is stopped, for example, during periodic inspection of the geothermal power generation system. Alternatively, a scale removal method can also be implemented when a contamination tolerance value determined for each device such as a turbine that constitutes the geothermal power generation system is exceeded. The details of the removal method are as described in the third embodiment above and can be carried out by immersing the device in each chemical agent or spraying the device with the chemical agent.

Note that the geothermal power generation system in which the method for suppressing scale adhesion according to the present embodiment is implemented is not limited to the illustrated binary cycle-type geothermal power generation system and can be applied to any geothermal power generation system.

The scale removal method according to the present embodiment enables scale adhering to be removed effectively, economically, and safely by selecting optimal chemical agents, using a combination of a penetrant, an inducer, and a remover selected depending on the base material and scale of interest of the devices constituting the geothermal power generation system, in relation to not only scale to be generated but also the base material to which the scale adheres.

### Example

Hereinafter, the present invention will be described in detail by way of an example. However, the following examples do not limit the present invention.

In a model plant of a geothermal power generation system, HSP coordinates A of the entire scale of interest, HSP coordinates B of the surface on the base material side of the scale of interest, and HSP coordinates C of the base material of interest were obtained according to the first to third steps of the first embodiment. Table 1 shows the coordinates. Next, Formula (I) was calculated with Ra=5 based on HSP coordinates A below according to the fourth step, to search for the corresponding compounds using a database. As a result, acetone having the HSP coordinates D below was selected as a penetrant. According to the fifth step, the recommended coordinates of a remover in the case of t₁=0.5, that is, in the middle of HSP coordinates B and HSP coordinates C were calculated. Based on the recommended coordinates, a compound satisfying the conditions of the remover in the fifth step with Ra=5 was searched for using the database. As a result, 2-(furan-2-ylmethyldisulfanylmethyl)furan having the HSP coordinates E below was selected as a remover. According to the sixth step, the recommended coordinates of an inducer in the case of t₂=0.5, that is, in the middle of the HSP coordinates D and the HSP coordinates E were calculated. Based on this, a compound satisfying the conditions of the inducer of the sixth step with Ra=5 was searched for using the database. As a result, dichloromethane having HSP coordinates F below was selected as an inducer.

TABLE 1

| Coordinates/Recommended coordinates | Coordinate values (δD/δP/δH) |
|---|---|
| Entire scale Coordinates A | 17.0/10.4/6.2 |
| Surface of scale Coordinates B | 18.8/8.9/3.3 |
| Base material Coordinates C | 20.5/6.0/9.6 |
| Penetrant Coordinates D | 15.5/10.4/7.0 |
| Recommended coordinates of remover | 19.7/7.5/6.5 |
| Remover Coordinates E | 18.6/7.6/6.2 |
| Recommended coordinates of inducer | 17.1/9.0/6.6 |
| Inducer Coordinates F | 17.0/7.3/7.1 |

### INDUSTRIAL APPLICABILITY

The method for selecting chemical agents for removing scale and the method for removing scale by the present invention can be applied to various plant systems, and in particular, to scale removal in geothermal power generation systems.

### REFERENCE SYMBOL LIST

A: HSP coordinates of entire scale of interest
B: HSP coordinates of surface on base material side of scale of interest
C: HSP coordinates of base material of interest
D: Penetrant
E: Remover
F: Inducer
1 Base material
2: Surface on base material side of scale
3: Scale
31 and 32: Scale pieces

1. A method for selecting chemical agents for removing scale, the method comprising steps of:
obtaining coordinates A of an intrinsic physical property value based on a Hansen solubility parameter of an entire scale of interest;
obtaining coordinates B of an intrinsic physical property value based on a Hansen solubility parameter of a surface on a base material side of the scale of interest;
obtaining coordinates C of an intrinsic physical property value based on a Hansen solubility parameter of a base material of interest;
selecting a penetrant having coordinates D of an intrinsic physical property value based on a Hansen solubility parameter based on an interaction radius Ra of the scale of interest with the coordinates A at the center;
selecting a remover having coordinates E of an intrinsic physical property value based on a Hansen solubility parameter based on a positional relationship between the coordinates B and the coordinates C; and
selecting an inducer having coordinates F of an intrinsic physical property value based on a Hansen solubility parameter based on a positional relationship between the coordinates D and the coordinates E.

2. The selection method according to claim 1, wherein
when the coordinates of the intrinsic physical property values are represented by three-dimensional coordinates composed of a dispersion force δD, a dipole force δP, and a hydrogen bonding force δH, and
when the coordinates A are referred to as (δDA, δPA, δHA),
the coordinates D are referred to as (δDD, δPD, δHD), and
the interaction radius is referred to as Ra,
the step of selecting a penetrant is selecting a material having coordinates D satisfying Formula (I) below:
$$4 ( δ DA - δ DD ) \hat{} 2 + ( δ PA - δ PD ) \hat{} 2 + ( δ HA - δ HD ) \hat{} 2 \leq {( Ra )}^{∧} 2 \qquad ( I )$$
as the penetrant.

3. The selection method according to claim 1, wherein
when the coordinates B are referred to as (δDB, δPB, δHB),
the coordinates C are referred to as (δDC, δPC, δHC),
the coordinates E are referred to as (δDE, δPE, δHE), and
the interaction radius is referred to as Ra,
the step of selecting a remover is selecting a material having coordinates E falling within an area represented by the locus of a sphere with the center on a line segment BC and with a radius Ra based on the Hansen solubility sphere and satisfying Formula (II) below:
$$( δ DB , δ PB , δ HB ) \leq ( δ DE , δ PE , δ HE ) \leq ( δ D C , δ PC , δ HC ) \qquad ( II )$$
$$or ( δ DB , δ PB , δ HB ) > ( δ DE , δ PE , δ HE ) > ( δ D C , δ PC , δ HC )$$
as the remover.

4. The selection method according to claim 3, wherein
when the coordinates F are referred to as (δDF, δPF, δHF), and
the interaction radius is referred to as Ra,
the step of selecting an inducer is selecting a material having coordinates F falling within an area represented by the locus of a sphere with the center on a line segment DE and with a radius Ra based on the Hansen solubility sphere and satisfying formula (III) below:
$$( δ DD , δ PD , δ HD ) \leq ( δ DF , δ PF , δ H F ) \leq ( δ DE , δ PE , δ HE ) \qquad ( III )$$
$$or ( δ DD , δ PD , δ HD ) > ( δ DF , δ PF , δ H F ) > ( δ DE , δ PE , δ HE )$$
as the inducer.

5. A method for removing scale, comprising steps of:
selecting a penetrant, an inducer, and a remover based on the selection method according to claim 1; and
applying the penetrant, the inducer, and the remover selected by the selection step to the scale of interest in this order or substantially simultaneously.

6. The method for removing scale according to claim 5, further comprising a step of applying a physical force to the scale of interest and/or a step of applying a corrosion inhibitor to the scale of interest.

7. A method for removing scale in a geothermal power generation system, the method comprising steps of:
selecting, for each of a plurality of devices constituting the geothermal power generation system, a penetrant, an inducer, and a remover for the device based on the selection method according to claim 1; and
applying, for each of the plurality of devices, the penetrant, the inducer, and the remover selected by the selection step to the scale of interest in this order or substantially simultaneously.
